(19) United States
(12) Patent Application Publication
(10) Pub. No.: US 2023/0053243 A1
(43) Pub. Date: Feb. 16, 2023

(54) Hybrid Performance Critic for Planning Module's Parameter Tuning in Autonomous Driving Vehicles

(71) Applicant: Baidu USA LLC, Sunnyvale, CA (US)

(72) Inventors: WEIMAN LIN, Sunnyvale, CA (US); QI LUO, Sunnyvale, CA (US); SHU JIANG, Sunnyvale, CA (US); YU CAO, Sunnyvale, CA (US); YU WANG, Sunnyvale, CA (US); JIAMING TAO, Sunnyvale, CA (US); KECHENG XU, Sunnyvale, CA (US); HONGYI SUN, Sunnyvale, CA (US)

(21) Appl. No.: 17/444,877

(22) Filed: Aug. 11, 2021

(51) Int. Cl. B60W 60/00; B60W 30/095; B60W 40/02; G06N 20/00

(52) U.S. Cl. CPC B60W 60/0015; B60W 30/0956; B60W 40/02; G06N 20/00; B60W 2554/80; B60W 2555/60

(57) ABSTRACT

One or more outputs from a planning module of an ADV are received. Data of a driving environment of the ADV is received. A performance of the planning module is evaluated by determining a score of the performance of the planning module based on the data of the driving environment and the one or more outputs from the planning module. Whether the one or more outputs from the planning module violates at least one of a set of safety rules is determined. The score is determined being larger than a predetermined threshold in response to determining that the one or more outputs from the planning module violate at least one of the set of safety rules. Otherwise, the score is determined based on a machine learning model. The planning module is modified by tuning a set of parameters of the planning module based on the score.

### TECHNICAL FIELD

Embodiments of the present disclosure relate generally to operating autonomous driving vehicles. More particularly, embodiments of the disclosure relate to evaluating the performance of an autonomous driving vehicle (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. An ADV may have a planning module which plans a path or route for the ADV, as well as driving parameters (e.g., distance, speed, and/or turning angle). Evaluating the performance of the planning module of the ADV is important to understand how the planning module would perform onboard. However, it is challenging to know what metrics to measure and how to evaluate the performance.

Previously, vast amount of hand-pick metrics are designed by experienced engineers to evaluate the performance of the planning module. For instance, 40 performance metrics in different aspects including control performance, safety performance, sensation performance and control source usage performance may be used. However, such hand-pick metrics may require engineers' familiarity on the particular fields and may be time-consuming.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a decision and a planning processes according to one embodiment.

FIGS. 5A-5B are block diagrams illustrating an example of an evaluation module for a planning module of an autonomous driving vehicle according to one embodiment.

FIG. 6A is flow diagram illustrating an example of a process of evaluating a planning module of an autonomous driving vehicle according to one embodiment.

FIG. 6B is block diagram illustrating an example of a collision check in a process of evaluating a planning module of an autonomous driving vehicle according to one embodiment.

FIG. 7 is a block diagram illustrating an example of a platform providing evaluation services to autonomous driving vehicles according to one embodiment.

FIG. 8 is a flow diagram illustrating a process of improving a planning module of an autonomous driving vehicle according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a hybrid performance critic to evaluate the performance of a planning module of an ADV is provided. Outputs (e.g. planning trajectory, obstacle information) from the planning module and the data from the surrounding environment may be input into the performance critic. The performance critic may combine a rule based safety evaluation and a machine learning (ML) model based evaluation of the performance of the planning module. At first, if there's any potential safety violation may be checked. If safety violations are found, the performance critic may return a large number that is greater than whatever the ML model can produce. If no safety issues are found, the performance of the planning module may be evaluated based on the ML model. The ML model may be trained to focus on learning from trajectories of experts (e.g., human drivers). The closer the outputs of the planning module to the trajectories of the human drivers, the better the performance of the planning module, and the lower the score of the planning module. The performance critic may improve the performance of the planning module, e.g., during the process of tuning a set of parameters of the planning module. Based on performance critic, an optimal set of parameters may be found to achieve an optimal performance of the planning module.

According to some embodiments, one or more outputs from a planning module of an ADV are received. The one or more outputs includes a planned trajectory for the ADV, and the planning module may include a set of parameters. Data of a driving environment of the ADV is received. A performance of the planning module is evaluated by determining a score of the performance of the planning module based on the data of the driving environment and the one or more outputs from the planning module. Whether the one or more outputs from the planning module violates at least one of a set of safety rules is determined. The score is determined being larger than a predetermined threshold in response to determining that the one or more outputs from the planning module violate at least one of the set of safety rules. The score is determined based on a machine learning model in response to determining that the one or more outputs from the planning module don't violate at least one of the set of safety rules. The planning module is modified by tuning the set of parameters based on the score. The ADV is controlled to drive autonomously according to a modified trajectory generated by the modified planning module.

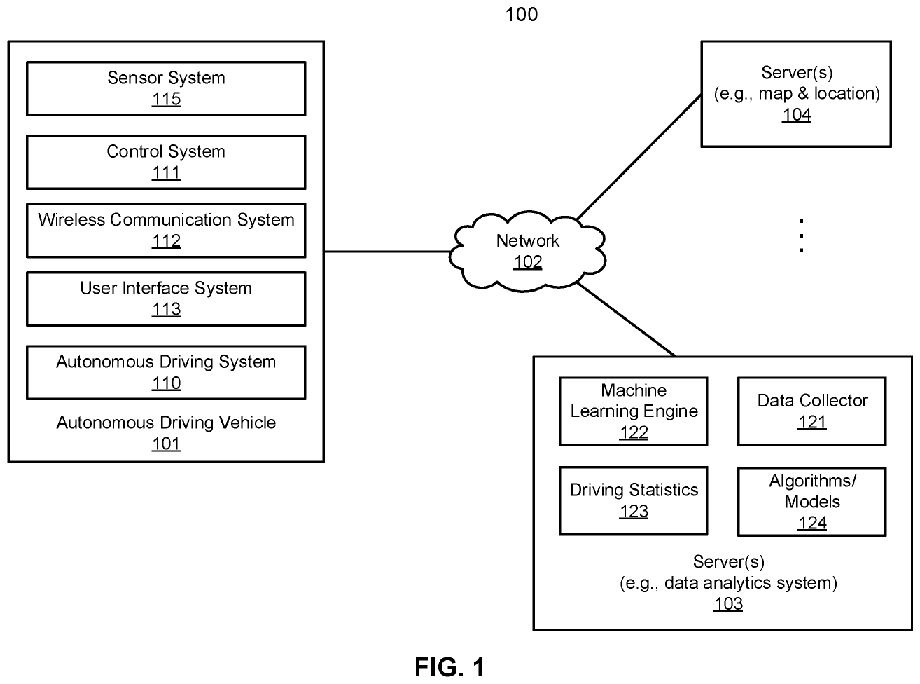

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

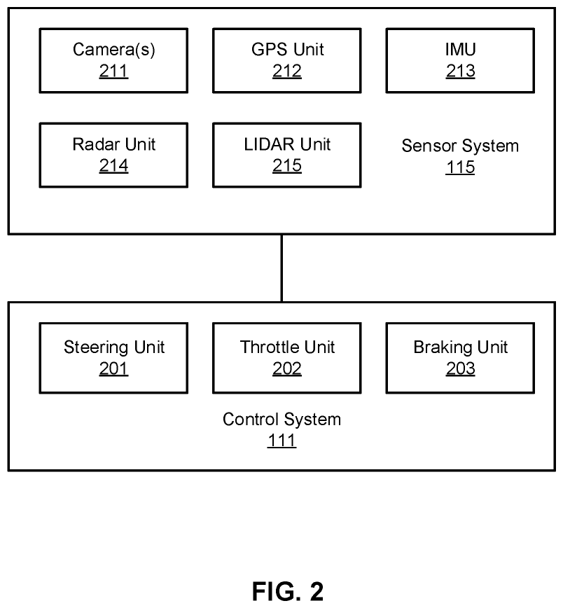

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. Algorithms 124 can then be uploaded on ADVs to be utilized during autonomous driving in real-time.

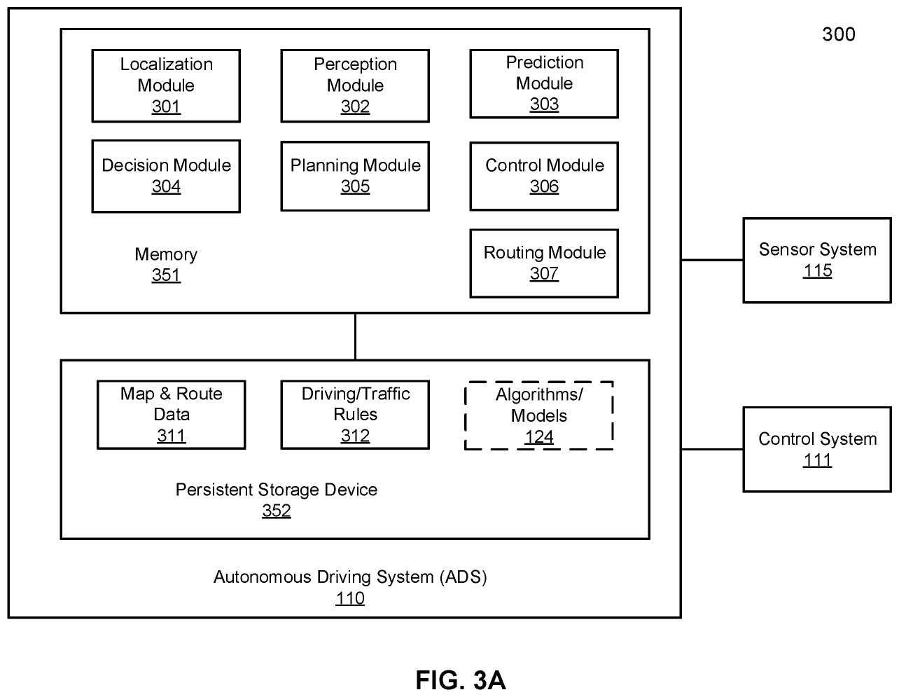

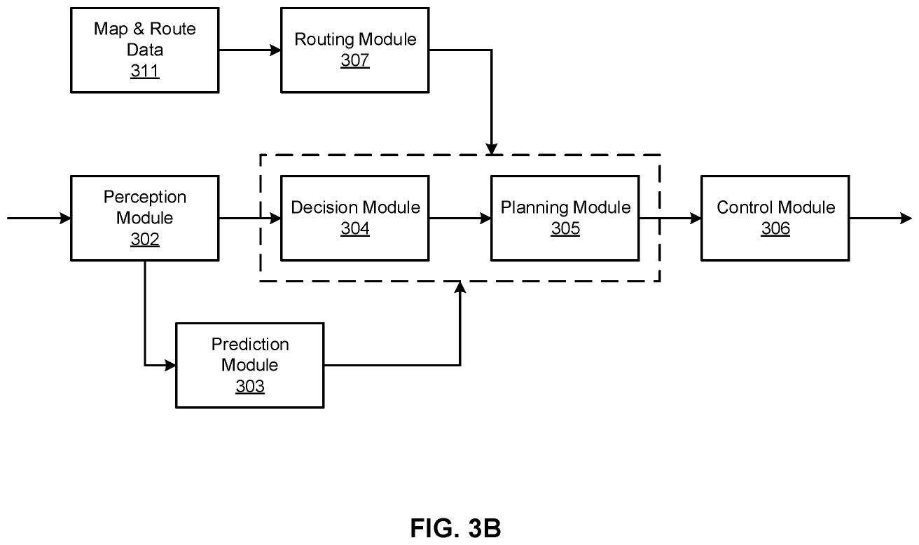

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/rout information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 300 would move in a next moving cycle (e.g., next route/path segment). For example, the planning and control data may instruct vehicle 300 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

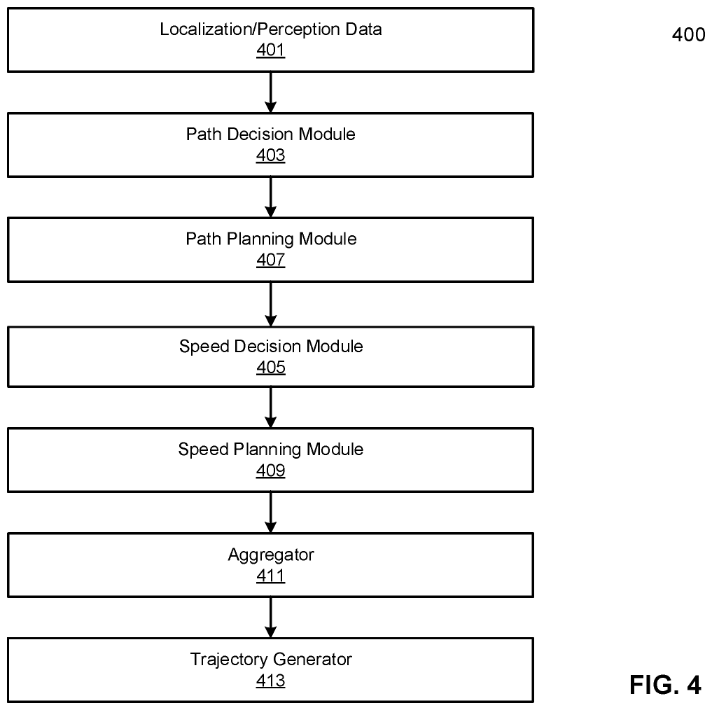

FIG. 4 is a block diagram illustrating an example of a decision and planning system according to one embodiment. System 400 may be implemented as part of autonomous driving system 300 of FIGS. 3A-3B to perform path planning and speed planning operations. Referring to FIG. 4, Decision and planning system 400 (also referred to as a planning and control or PnC system or module) includes, amongst others, routing module 307, localization/perception data 401, path decision module 403, speed decision module 405, path planning module 407, speed planning module 409, aggregator 411, and trajectory calculator 413.

Path decision module 403 and speed decision module 405 may be implemented as part of decision module 304. In one embodiment, path decision module 403 may include a path state machine, one or more path traffic rules, and a station-lateral maps generator. Path decision module 403 can generate a rough path profile as an initial constraint for the path/speed planning modules 407 and 409 using dynamic programming.

In one embodiment, the path state machine includes at least three states: a cruising state, a changing lane state, and/or an idle state. The path state machine provides previous planning results and important information such as whether the ADV is cruising or changing lanes. The path traffic rules, which may be part of driving/traffic rules 312 of FIG. 3A, include traffic rules that can affect the outcome of a path decisions module. For example, the path traffic rules can include traffic information such as construction traffic signs nearby the ADV can avoid lanes with such construction signs. From the states, traffic rules, reference line provided by routing module 307, and obstacles perceived by perception module 302 of the ADV, path decision module 403 can decide how the perceived obstacles are handled (i.e., ignore, overtake, yield, stop, pass), as part of a rough path profile.

For example, in one embedment, the rough path profile is generated by a cost function including costs based on: a curvature of path and a distance from the reference line and/or reference points to obstacles. Points on the reference line are selected and are moved to the left or right of the reference lines as candidate movements representing path candidates. Each of the candidate movements has an associated cost. The associated costs for candidate movements of one or more points on the reference line can be solved using dynamic programming for an optimal cost sequentially, one point at a time.

In one embodiment, a state-lateral (SL) maps generator (not shown) generates an SL map as part of the rough path profile. An SL map is a two-dimensional geometric map (similar to an x-y coordinate plane) that includes obstacles information perceived by the ADV. From the SL map, path decision module 403 can lay out an ADV path that follows the obstacle decisions. Dynamic programming (also referred to as a dynamic optimization) is a mathematical optimization method that breaks down a problem to be solved into a sequence of value functions, solving each of these value functions just once and storing their solutions. The next time the same value function occurs, the previous computed solution is simply looked up saving computation time instead of recomputing its solution.

Speed decision module 405 or the speed decision module includes a speed state machine, speed traffic rules, and a station-time graphs generator (not shown). Speed decision process 405 or the speed decision module can generate a rough speed profile as an initial constraint for the path/speed planning modules 407 and 409 using dynamic programming. In one embodiment, the speed state machine includes at least two states: a speed-up state and/or a slow-down state. The speed traffic rules, which may be part of driving/traffic rules 312 of FIG. 3A, include traffic rules that can affect the outcome of a speed decisions module. For example, the speed traffic rules can include traffic information such as red/green traffic lights, another vehicle in a crossing route, etc. From a state of the speed state machine, speed traffic rules, rough path profile/SL map generated by decision module 403, and perceived obstacles, speed decision module 405 can generate a rough speed profile to control when to speed up and/or slow down the ADV. The SL graphs generator can generate a station-time (ST) graph as part of the rough speed profile.

In one embodiment, path planning module 407 includes one or more SL maps, a geometry smoother, and a path costs module (not shown). The SL maps can include the station-lateral maps generated by the SL maps generator of path decision module 403. Path planning module 407 can use a rough path profile (e.g., a station-lateral map) as the initial constraint to recalculate an optimal reference line using quadratic programming. Quadratic programming (QP) involves minimizing or maximizing an objective function (e.g., a quadratic function with several variables) subject to bounds, linear equality, and inequality constraints.

One difference between dynamic programming and quadratic programming is that quadratic programming optimizes all candidate movements for all points on the reference line at once. The geometry smoother can apply a smoothing algorithm (such as B-spline or regression) to the output station-lateral map. The path costs module can recalculate a reference line with a path cost function, to optimize a total cost for candidate movements for reference points, for example, using QP optimization performed by a QP module (not shown). For example, in one embodiment, a total path cost function can be defined as follows:

path cost=Σₚₒᵢₙₜₛ(heading)²+Σₚₒᵢₙₜₛ(curvature)²+Σₚₒᵢₙₜₛ(distance)²,

where the path costs are summed over all points on the reference line, heading denotes a difference in radial angles (e.g., directions) between the point with respect to the reference line, curvature denotes a difference between curvature of a curve formed by these points with respect to the reference line for that point, and distance denotes a lateral (perpendicular to the direction of the reference line) distance from the point to the reference line. In some embodiments, distance represents the distance from the point to a destination location or an intermediate point of the reference line. In another embodiment, the curvature cost is a change between curvature values of the curve formed at adjacent points. Note the points on the reference line can be selected as points with equal distances from adjacent points. Based on the path cost, the path costs module can recalculate a reference line by minimizing the path cost using quadratic programming optimization, for example, by the QP module.

Speed planning module 409 includes station-time graphs, a sequence smoother, and a speed costs module. The station-time graphs can include a ST graph generated by the ST graphs generator of speed decision module 405. Speed planning module 409 can use a rough speed profile (e.g., a station-time graph) and results from path planning module 407 as initial constraints to calculate an optimal station-time curve. The sequence smoother can apply a smoothing algorithm (such as B-spline or regression) to the time sequence of points. The speed costs module can recalculate the ST graph with a speed cost function to optimize a total cost for movement candidates (e.g., speed up/slow down) at different points in time.

For example, in one embodiment, a total speed cost function can be:

speed cost=Σₚₒᵢₙₜₛ(speed′)²+Σₚₒᵢₙₜₛ(speed″)²+(distance)²,

where the speed costs are summed over all time progression points, speed′ denotes an acceleration value or a cost to change speed between two adjacent points, speed″ denotes a jerk value, or a derivative of the acceleration value or a cost to change the acceleration between two adjacent points, and distance denotes a distance from the ST point to the destination location. Here, the speed costs module calculates a station-time graph by minimizing the speed cost using quadratic programming optimization, for example, by the QP module.

Aggregator 411 performs the function of aggregating the path and speed planning results. For example, in one embodiment, aggregator 411 can combine the two-dimensional ST graph and SL map into a three-dimensional SLT graph. In another embodiment, aggregator 411 can interpolate (or fill in additional points) based on two consecutive points on an SL reference line or ST curve. In another embodiment, aggregator 411 can translate reference points from (S, L) coordinates to (x, y) coordinates.

In one embodiment, Trajectory generator 413 can calculate the final trajectory to control ADV 510. For example, based on the SLT graph provided by aggregator 411, trajectory generator 413 calculates a list of (x, y, T) points indicating at what time should the ADC pass a particular (x, y) coordinate.

Thus, path decision module 403 and speed decision module 405 are configured to generate a rough path profile and a rough speed profile taking into consideration obstacles and/or traffic conditions. Given all the path and speed decisions regarding the obstacles, path planning module 407 and speed planning module 409 are to optimize the rough path profile and the rough speed profile in view of the obstacles using QP programming to generate an optimal planned trajectory with minimum path cost and/or speed cost.

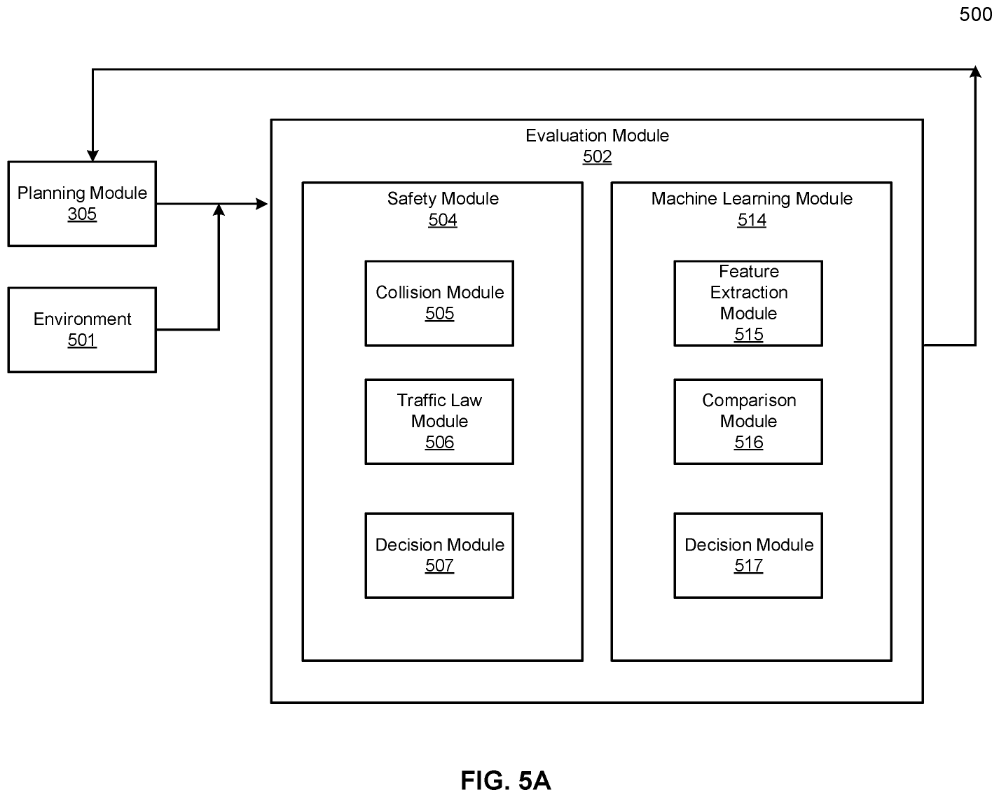

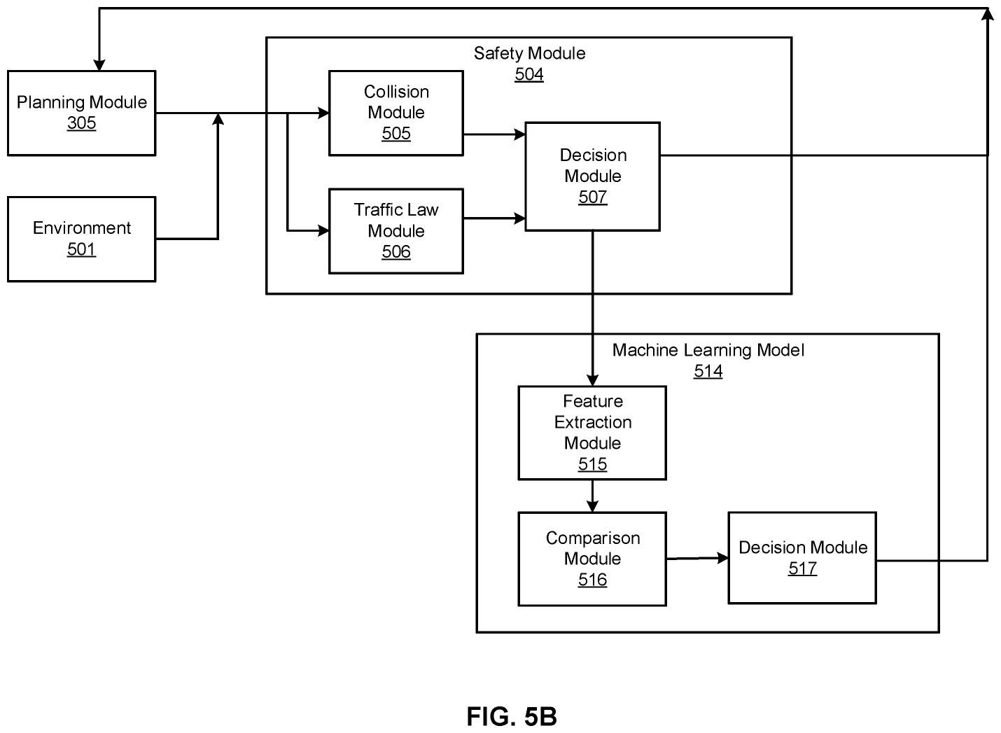

FIGS. 5A-5B are block diagrams illustrating an example of an evaluation module 500 for a planning module (e.g., 305, 407, 409) of an ADV according to one embodiment. As discussed above, the planning module (e.g., 305, 407, 409) may plan a path or route for the ADV, as well as driving parameters (e.g., distance, speed, and/or turning angle). The planning module (e.g., 305, 407, 409) may generate a planned trajectory with minimum path cost and/or speed cost. Outputs of the planning module (e.g., 305, 407, 409) may include the planned trajectory, a heading direction of the ADV, a speed of the ADV, an acceleration of the ADV, a distance to an obstacle of the ADV, obstacle information from different directions, a predicated trajectory of an obstacle, a road/lane configuration, etc. The planning module (e.g., 305, 407, 409) may include a set of parameters, such as a weighting factor of speed, a weighting factor of acceleration, a weighting factor of jerk, a weighting factor of a safety distance between an obstacle and the ADV, or a weighting factor of a gap between a reference speed and a planned speed, etc. The performance of the planning module may be based on the outputs of the planning module. The outputs of the planning module may be based on the set of parameters.

Evaluating the performance of the planning module of the ADV is important to understand how the planning module would perform onboard, thereby improving the safety and performance of the planning module. It is advantageous to develop a method and/or system that provides an evaluation of the performance of the planning module of the ADV. The evaluation of the performance of the planning module may analyze the planning module in various perspectives, in order to improve the performance of the planning module at the right direction, e.g., during the process of tuning the planning module tuning. The process of tuning the planning module may include finding an optimal set of parameters to achieve an optimized performance of the planning module.

Referring to FIG. 5A and FIG. 5B, the evaluation module 500 for the planning module of the ADV may include a hybrid version of performance evaluation or critic that requires little familiarity in particular fields. The evaluation module 500 may include both a traffic rule based evaluation and a machine learning based evaluation of the performance of the planning module.

The evaluation module 500 may include a safety module 504 and a machine learning (ML) model 514. The safety module 504 may include a collision module 505, a traffic law module 506, and/or a decision module 507. The ML module 514 may include a feature extraction module 515, a comparison module 516, a decision module 517. Some or all of the modules of the evaluation module 500 may be implemented in software, hardware, or a combination thereof. For example, modules 504-507, 514-517 may be installed in a persistent storage device, loaded into a memory, and executed by one or more processors (not shown). Note that some or all of these modules may be communicatively coupled to or integrated. Some of modules 505-507, 515-517 may be integrated together as an integrated module.

The evaluation module 500 may evaluate the performance of the planning module by determining a score of the performance of the planning module, based on outputs from the planning module (e.g., 305, 407, 409) and data from a driving environment module 501. The score of the performance of the planning module may be based on traffic rules and/or the ML model. The data from the driving environment module 501 may include data from a map, from sensors mounted on the ADV, from GPS, or from a server, etc. The data from the driving environment module 501 may include obstacle information, a road structure, a traffic situation, etc.

The evaluation module 500 may be used in simulation environment, for example, during a process of parameter tuning to test the set of parameter of the planning module efficiently. The evaluation module 500 may combine the safety module 504 and the ML module 514 to evaluate the performance of the planning module. The evaluation module 500 may take outputs (e.g. planning trajectory, obstacle information) of the planning module as its input, and returns the score, e.g., a positive score, as the evaluation result of the planning module. In one embodiment, the smaller the score, the better the performance of the planning module.

The safety module 504 is configured to determine whether outputs from the planning module, e.g., the planned trajectory, obstacle information, etc., violates at least one of a set of safety rules. The safety module 504 may check if there's any potential safety violations based on safety rules. As safety is the top priority in an autonomous driving system for the ADV, avoiding danger is very important for the planning module. The safety module 504 may determine the score being larger than a predetermined threshold in response to determining that the trajectory violates at least one of the set of safety rules.

The collision module 505 is configured to determine whether the outputs from the planning module, e.g., the planned trajectory, would result in a collision of the ADV. The traffic law module 506 is configured to determine whether the outputs from the planning module, e.g., the planned trajectory, has a traffic law violation including a traffic light violation, a speed limit violation, or a lane changing guideline violation. For example, the traffic law module 506 may check whether the ADV keeps certain safety distance during a lane-follow scenario, whether there is not a rear-end collision during an emergency stop, whether the ADV follows lane changing guideline, whether there are no red or yellow light violations, or whether there are no speed limit violations.

The decision module 507 is configured to determine the score being larger than a predetermined threshold in response to determining that the outputs from the planning module violates at least one of the set of safety rules. If there is a safety violation, the decision module 507 may return a number greater than a predetermined threshold that the ML model can produce, to indicate this module output is unacceptable.

If there are no safety issues, the performance of the planning module may be evaluated in the ML learning model 514. The ML learning module 514 may include a deep learning model which may be trained with any neuron network. The ML learning module 514 may be based on the data of the driving environment and the outputs from the planning module This data-driven ML learning module 514 may assume human driving is the desired behavior. The ML learning module 514 may be trained to focus on learning trajectories from experts, e.g., human drivers. The closer the outputs of the planning module to the human drivers, the better the performance of the planning module, and the lower the score of the planning module.

The feature extraction module 515 is configured to extract a set of features based on the outputs from the planning module and the data of the surrounding driving environment of the ADV. The set of features may include one or more of obstacle information from different directions, a road structure, a status of the ADV, a velocity of the ADV, an acceleration of the ADV, or a jerk of the ADV. The obstacle information may include a size of an obstacle, a distance to the obstacle, a predicted trajectory of the obstacle, etc. The directions of the obstacle may include a front direction, a front-left direction, a front-right direction, a left direction, a right direction, a rear-left direction, a rear-right direction, a rear direction, etc. The road structure may include a lane configuration, a solid line of a lane boundary, a dash line of a lane boundary, a curvature of a lane, a slope of a lane, etc. The status of the ADV may include a lane-following status, a lane-changing, a freeway-exiting status, etc. The set of features may be used to train the ML module 514. The set of features may be used to compare the performance of the planning module with the performance of human drivers. In one embodiment, a same set of features may be used to train the ML module 514 and compare the performance of the planning module with the performance of human drivers. In another embodiment, a first set of features may be used to train the ML module 514, and a second set of features may be used to compare the performance of the planning module with the performance of human drivers.

The comparison module 516 may be configured to compare the performance of the planning module with the performance of human drivers. A set of trajectories from the human drivers may be previously collected. A set of features may be extracted from the set of trajectories from the human drivers. The set of features extracted from outputs of the planning module may be compared with the set of features extracted from the set of trajectories from the human drivers.

The decision module 517 may be configured to determine the score of the performance of the planning module based on the comparison result from the comparison module 516. The score of the performance of the planning module may be determined based on a similarity between the set of features extracted from the planning module and the set of features extracted from the set of trajectories previously collected from the human drivers. The goal of the ML model 514 is to determine if the set of features extracted from the planning module are similar to human behaviors. The closer to the human driving behavior, the better the performance, and the lower the score. When the set of features extracted from the planning module are more similar to the set of features extracted from the set of trajectories previously collected from the human drivers, the performance of the planning module is better, and the score of the performance of the planning module is lower, and vice versa.

The set of parameters of the planning module, including, but not being limited to, a weighting factor of speed, a weighting factor of acceleration, a weighting factor of jerk, a weighting factor of a safety distance between an obstacle and the ADV, or a weighting factor of a gap between a reference speed and a planned speed, may be tuned based on the score of the performance of the planning module. Thus, the planning module may be tuned or modified until the score being a lowest score. In this way, the performance of the planning module may be improved.

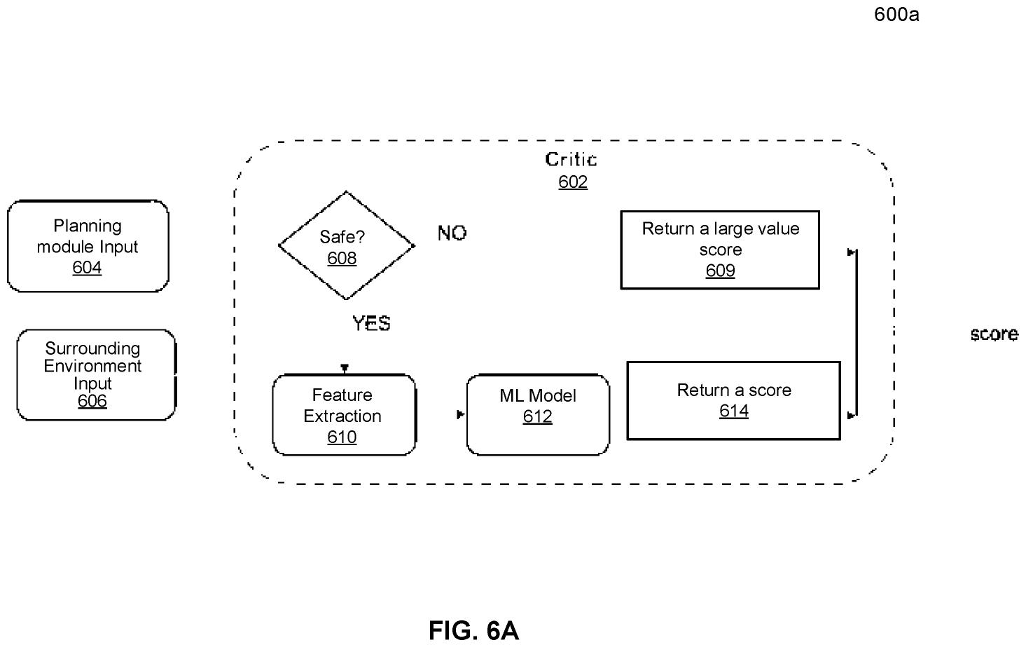

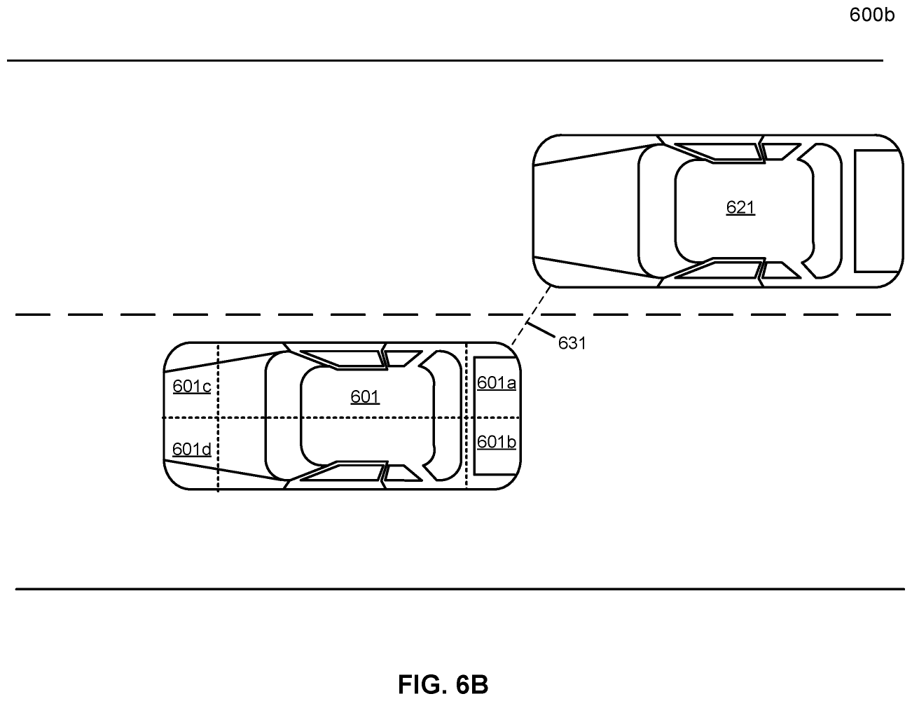

FIG. 6A is a diagram 600a illustrating an example of a process of evaluating a planning module of an autonomous driving vehicle according to one embodiment. Profiling the performance on the planning module of an ADV is important as it helps on understanding how the planning module will perform onboard. A process of a performance critic 602 may provide an evaluation that may analyze the planning module in various perspectives, in order to improve the performance of the planning module at the right direction, e.g., during the process of tuning the planning module tuning. The process of tuning the planning module may include finding an optimal set of parameters that provides an optimal performance. The performance critic 602 may include a hybrid version of performance critic which may be used to evaluate the performance of the planning module of the ADV. The performance critic 602 may be performed, for example, by the evaluation module 502 as discussed in connection with FIG. 5A and FIG. 5B.

Referring to FIG. 6A, the performance critic 602 may be performed in a simulation environment, for example, during a process of parameter tuning to test a set of parameter of the planning module efficiently. The performance critic 602 may combine a rule based safety evaluation and an ML learning based evaluation to evaluate the performance of the planning module of the ADV. The performance critic 602 may a safety decider (e.g., 504) and an ML model (e.g., 514) to evaluate module's performance.

At block 604, outputs (e.g. planning trajectory, obstacle information) of the planning module may be input into the critic 602 to evaluate the performance of the planning module.

At block 606, surrounding environment data including obstacle information, road structure, etc., from maps, GPS, or sensors of the ADV may be input into the critic 602 to evaluate the performance of the planning module.

At block 608, the critic 602 may perform a ruled-based safety check. The critic 602 may check if there's any potential safety violation. As safety is the top priority in an ADV, avoiding danger is important for the planning module. The process of the ruled-based safety check may be based on rules, e.g., traffic rules.

As the ML model learning-based model depends on the data from the planning module and the surrounding environment, to prevent edge cases or unseen cases not being covered, the ruled-based safety check may focus on (but not being limited to) a collision check and a traffic law violation check. Thus, the ruled-based safety check may ensure no collisions from a planned trajectory and all traffic laws are obeyed.

For example, the ruled-based safety check may check whether the ADV keeps certain safety distance during a lane-follow scenario, whether there is not a rear-end collision during an emergency stop, whether the ADV follows lane changing guideline, whether there are no red or yellow light violations, or whether there are no speed limit violations.

In one embodiment, the collision check may include checking whether a planned trajectory of the planning module would result in a collision of the ADV. For example, as illustrated in FIG. 6B, an ADV 601 may be split into multiple sections 601a, 601b, 601c, 601d, etc. For each of the multiple sections of the ADV 601, a closest object to a section of the ADV may be determined, and whether a distance between the closest object to the section of the ADV is within a predetermined threshold may be determined. If the distance between the closest object to the section of the ADV is within the predetermined threshold, the planned trajectory would result in a collision of the ADV. As an example, for a front left section 601a of the ADV 601, a closest object may be an ADV 621. Whether a distance 631 between the closest object 621 to the section 601a of the ADV 601 is within the predetermined threshold may be determined. If the distance 631 between the closest object 621 to the section 601a of the ADV 601 is within the predetermined threshold, the planned trajectory would result in a collision of the ADV.

Referring back to FIG. 6A, at block 609, if safety violations were found, the performance of the planning module may be considered as unacceptable. Hence, to indicate the outputs of the planning module are unacceptable, the critic 602 may return a large number that is greater than whatever the ML model can produce.

At block 610, a set of features may be extracted from the planning module. If there are no safety issues, the performance of the planning module may be evaluated in the ML learning model. The ML learning module may include a deep learning model which may be trained with any neuron network. This data-driven ML learning module may assume human driving is the desired behavior. The ML learning module may be trained to focus on learning trajectories from experts, e.g., human drivers. The closer the outputs of the planning module to the trajectories of the human drivers, the better the performance of the planning module, and the lower the score of the planning module.

The set of features extracted from the planning module may include obstacle information from different directions, a road structure, a status of the ADV, a velocity of the ADV, an acceleration of the ADV, or a jerk of the ADV. The obstacle information may include a size of an obstacle, a distance to the obstacle, a predicted trajectory of the obstacle, etc. The directions of the obstacle may include a front direction, a front-left direction, a front-right direction, a left direction, a right direction, a rear-left direction, a rear-right direction, a rear direction, etc. The road structure may include a lane configuration, a solid line of a lane boundary, a dash line of a lane boundary, a curvature of a lane, a slope of a lane, etc. The status of the ADV may include a lane-following status, a lane-changing, a freeway-exiting status, etc.

At block 612, the ML module may compare the performance of the planning module with the performance of human drivers based on the set of features. The ML model may be trained to learning expert (e.g., human drivers) trajectories. A set of trajectories from the human drivers may be previously collected. The ML model may compare the set of features extracted from outputs of the planning module with the set of features extracted from the trajectories from the human drivers.

At block 614, a score of the performance of the planning module may be returned. The score of the performance of the planning module may be determined based on a similarity between the set of features extracted from the planning module and the set of features extracted from the trajectories previously collected from the human drivers. The goal of the ML model is to determine if the set of features extracted from the planning module are similar to human behaviors. The closer to the human driving behavior, the better the performance, and the lower the score. When the set of features extracted from the planning module are more similar to the set of features extracted from the set of trajectories previously collected from the human drivers, the performance of the planning module is better, and the score of the performance of the planning module is lower, and vice versa. Thus, the set of parameters of the planning module may be tuned or modified until the score being a lowest score. In this way, an optimal set of parameters to achieve an optimal performance may be found. Thus, the performance of the planning module may be improved.

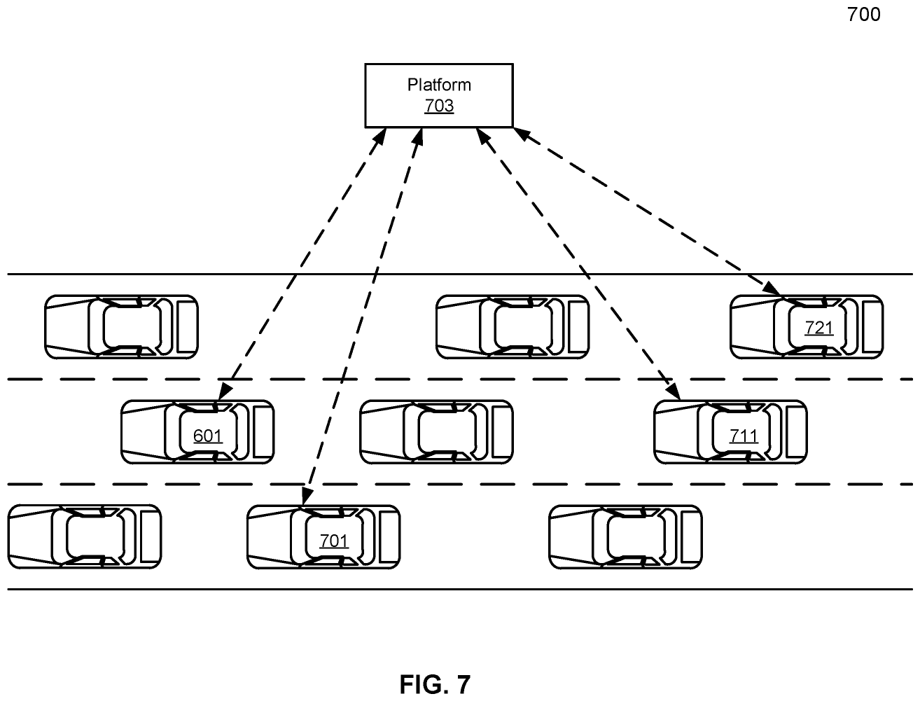

FIG. 7 is a block diagram illustrating an example of a platform 703 providing evaluation services to autonomous driving vehicles according to one embodiment. The platform 703 may be coupled to multiple ADVs 601, 701, 711, 721, etc., over a network. The network may be any type of networks such as a local area network (LAN), a wide area network (WAN) such as the Internet, a cellular network, a satellite network, or a combination thereof, wired or wireless. The platform 703 may be any kind of servers or a cluster of servers, such as Web or cloud servers, application servers, backend servers, or a combination thereof. The platform 703 may be data analytics servers, content servers, traffic information servers, map and point of interest (MPOI) servers, or location servers, etc.

The platform 703 may include the evaluation module 502, as discussed in connection with FIG. 5A-FIG. 5B, to evaluate the performance of respective planning modules of the ADVs 601, 701, 711, 721. The performance of respective planning modules of the ADVs 601, 701, 711, 721 may be improved based on the evaluation services from the platform 703.

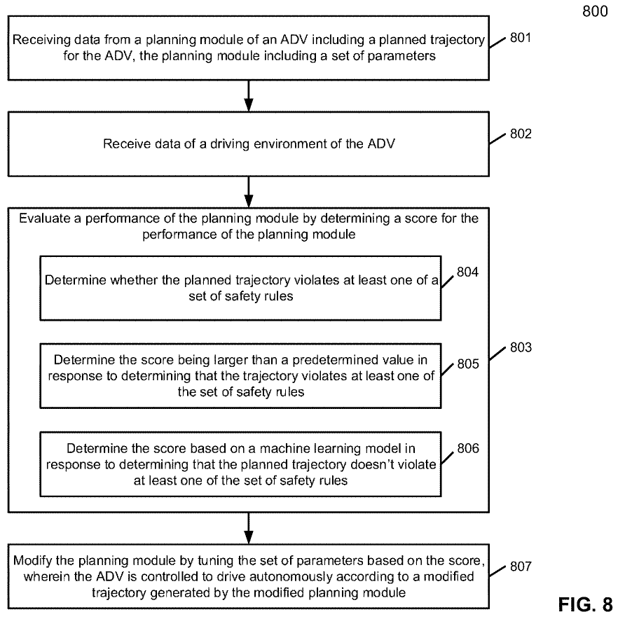

FIG. 8 is a flow diagram illustrating a process of improving a planning module of an autonomous driving vehicle according to one embodiment. Process 800 may be performed by processing logic which may include software, hardware, or a combination thereof. For example, process 800 may be performed by the evaluation module 502. Referring to FIG. 8, in operation 801, processing logic receives one or more outputs from a planning module of an autonomous driving vehicle (ADV), the one or more outputs including a planned trajectory for the ADV, the planning module including a set of parameter. In operation 802, processing logic, receives data of a driving environment of the ADV.

In operation 803, processing logic evaluates a performance of the planning module by determining a score of the performance of the planning module based on the data of the driving environment and the one or more outputs from the planning module. Operation 803 includes operations 804, 805, 806.

In operation 804, processing logic determines whether the one or more outputs from the planning module violates at least one of a set of safety rules.

In one embodiment, processing logic may determine whether the planned trajectory would result in a collision of the ADV.

In one embodiment, processing logic may determine whether the planned trajectory would result in a collision of the ADV by splitting the ADV into multiple sections. For each of the multiple sections of the ADV, processing logic may determine a closest object to a section of the ADV, and processing logic may determine whether a distance between the closest object to the section of the ADV is within a predetermined threshold. Processing logic may determine that the planned trajectory would result in a collision of the ADV in response to determining the distance between the closest object to the section of the ADV is within the predetermined threshold.

In one embodiment, processing logic may determine whether the planned trajectory has a traffic law violation including a traffic light violation, a speed limit violation, or a lane changing guideline violation.

In operation 805, processing logic determines the score being larger than a predetermined threshold in response to determining that the one or more outputs from the planning module violate at least one of the set of safety rules.

In operation 806, processing logic determines the score based on a machine learning model in response to determining that the one or more outputs from the planning module don't violate at least one of the set of safety rules.

In one embodiment, processing logic may extract a set of features based on the one or more outputs from the planning module and the data of the driving environment of the ADV.

In one embodiment, the set of features includes one or more of obstacle information from different directions, a road configuration, a status of the ADV, a velocity of the ADV, an acceleration of the ADV, or a jerk of the ADV.

In one embodiment, processing logic may determine compare the set of features extracted from the planning module with a set of features extracted from a set of trajectories previously collected from the human drivers, and processing logic may determine the score based on a similarity between the set of features extracted from the planning module and the set of features extracted from the set of trajectories previously collected from the human drivers.

In one embodiment, the set of parameters include one or more of a weighting factor of speed, a weighting factor of acceleration, a weighting factor of jerk, a weighting factor of a safety distance between an obstacle and the ADV, or a weighting factor of a gap between a reference speed and a planned speed.

In operation 806, processing logic modifies the planning module by tuning the set of parameters based on the score, wherein the ADV is controlled to drive autonomously according to a modified trajectory generated by the modified planning module.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
receiving one or more outputs of a planning module of an autonomous driving vehicle (ADV), representing a trajectory that was planned based on a set of parameters;
determining whether the one or more outputs from the planning module violates at least one of a set of rules in view of perception data perceiving a driving environment surrounding the ADV;
determining a score based on a violation of the set of rules, in response to determining that the one or more outputs from the planning module violate at least one of the set of rules, the score representing a performance of the planning module;
determining the score using a machine learning model based on the perception data and the one or more outputs, in response to determining that the one or more outputs from the planning module do not violate the set of rules; and
modifying the planning module by tuning the set of parameters based on the score, wherein the modified planning module is used to drive the ADV subsequently.

2. The method of claim 1, wherein the determining whether the one or more outputs violate at least one of a set of rules comprising determining whether the trajectory would result in a collision of the ADV.

3. The method of claim 2, wherein the determining whether the trajectory would result in a collision of the ADV comprising:
splitting the ADV into multiple sections;
for each of the multiple sections of the ADV,
determining a closest object to a section of the ADV;
determining whether a distance between the closest object to the section of the ADV is within a predetermined threshold; and
determining that the trajectory would result in a collision of the ADV in response to determining the distance between the closest object to the section of the ADV is within the predetermined threshold.

4. The method of claim 1, wherein the determining whether the one or more outputs violate at least one of a set of rules comprising determining whether the trajectory has a traffic law violation including a traffic light violation, a speed limit violation, or a lane changing guideline violation.

5. The method of claim 1, wherein the determining the score based on a machine learning model comprising extracting a set of features based on the one or more outputs from the planning module and the perception data of the driving environment of the ADV.

6. The method of claim 5, wherein the set of features includes one or more of obstacle information from different directions, a road configuration, a status of the ADV, a velocity of the ADV, an acceleration of the ADV, or a jerk of the ADV.

7. The method of claim 5, wherein the determining the score using a machine learning model comprising
comparing the set of features extracted from the planning module with a set of features extracted from a set of trajectories previously collected from human drivers; and
determining the score based on a similarity between the set of features extracted from the planning module and the set of features extracted from the set of trajectories previously collected from the human drivers.

8. The method of claim 1, wherein the set of parameters include one or more of a weighting factor of speed, a weighting factor of acceleration, a weighting factor of jerk, a weighting factor of a safety distance between an obstacle and the ADV, or a weighting factor of a gap between a reference speed and a planned speed.

9. A non-transitory machine-readable medium having instructions stored therein, which when executed by a processor, cause the processor to perform operations, the operations comprising:
receiving one or more outputs of a planning module of an autonomous driving vehicle (ADV), representing a trajectory that was planned based on a set of parameters;
determining whether the one or more outputs from the planning module violates at least one of a set of rules in view of perception data perceiving a driving environment surrounding the ADV;
determining a score based on a violation of the set of rules, in response to determining that the one or more outputs from the planning module violate at least one of the set of rules, the score representing a performance of the planning module;
determining the score using a machine learning model based on the perception data and the one or more outputs, in response to determining that the one or more outputs from the planning module do not violate the set of rules; and
modifying the planning module by tuning the set of parameters based on the score, wherein the modified planning module is used to drive the ADV subsequently.

10. The non-transitory machine-readable medium of claim 9, wherein the determining whether the one or more outputs violate at least one of a set of rules comprising determining whether the trajectory would result in a collision of the ADV.

11. The non-transitory machine-readable medium of claim 10, wherein the determining whether the trajectory would result in a collision of the ADV comprising:
splitting the ADV into multiple sections;
for each of the multiple sections of the ADV,
determining a closest object to a section of the ADV;
determining whether a distance between the closest object to the section of the ADV is within a predetermined threshold; and
determining that the trajectory would result in a collision of the ADV in response to determining the distance between the closest object to the section of the ADV is within the predetermined threshold.

12. The non-transitory machine-readable medium of claim 9, wherein the determining whether the one or more outputs violate at least one of a set of rules comprising determining whether the trajectory has a traffic law violation including a traffic light violation, a speed limit violation, or a lane changing guideline violation.

13. The non-transitory machine-readable medium of claim 9, wherein the determining the score based on a machine learning model comprising extracting a set of features based on the one or more outputs from the planning module and the perception data of the driving environment of the ADV.

14. The non-transitory machine-readable medium of claim 13, wherein the set of features includes one or more of obstacle information from different directions, a road configuration, a status of the ADV, a velocity of the ADV, an acceleration of the ADV, or a jerk of the ADV.

15. The non-transitory machine-readable medium of claim 13, wherein the determining the score using a machine learning model comprising
comparing the set of features extracted from the planning module with a set of features extracted from a set of trajectories previously collected from human drivers; and
determining the score based on a similarity between the set of features extracted from the planning module and the set of features extracted from the set of trajectories previously collected from the human drivers.

16. The non-transitory machine-readable medium of claim 9, wherein the set of parameters include one or more of a weighting factor of speed, a weighting factor of acceleration, a weighting factor of jerk, a weighting factor of a safety distance between an obstacle and the ADV, or a weighting factor of a gap between a reference speed and a planned speed.

17. A data processing system, comprising:
a processor; and
a memory coupled to the processor to store instructions, which when executed by the processor, cause the processor to perform operations, the operations including
receiving one or more outputs of a planning module of an autonomous driving vehicle (ADV), representing a trajectory that was planned based on a set of parameters,
determining whether the one or more outputs from the planning module violates at least one of a set of rules in view of perception data perceiving a driving environment surrounding the ADV,
determining a score based on violation of the set of rules, in response to determining that the one or more outputs from the planning module violate at least one of the set of rules, the score representing a performance of the planning module,
determining the score using a machine learning model based on the perception data and the one or more outputs, in response to determining that the one or more outputs from the planning module do not violate the set of rules, and
modifying the planning module by tuning the set of parameters based on the score, wherein the modified planning module is used to drive the ADV subsequently.

18. The system of claim 17, wherein the determining whether the one or more outputs violate at least one of a set of rules comprising determining whether the trajectory would result in a collision of the ADV.

19. The system of claim 18, wherein the determining whether the trajectory would result in a collision of the ADV comprising:
splitting the ADV into multiple sections;
for each of the multiple sections of the ADV,
determining a closest object to a section of the ADV;
determining whether a distance between the closest object to the section of the ADV is within a predetermined threshold; and
determining that the trajectory would result in a collision of the ADV in response to determining the distance between the closest object to the section of the ADV is within the predetermined threshold.

20. The system of claim 17, wherein the determining whether the one or more outputs violate at least one of a set of rules comprising determining whether the trajectory has a traffic law violation including a traffic light violation, a speed limit violation, or a lane changing guideline violation.
